(19) United States
(12) Patent Application Publication
(10) Pub. No.: US 2006/0248058 A1
(43) Pub. Date: Nov. 2, 2006

(54) Method, apparatus, and system for unifying heterogeneous data sources for access from online applications

(76) Inventor: Andrew An Feng, Cupertino, CA (US)

Correspondence Address: GLENN PATENT GROUP, 3475 EDISON WAY, SUITE L, MENLO PARK, CA, 94025, US

(21) Appl. No.: 11/118,985

(22) Filed: Apr. 28, 2005

(51) Int. Cl. G06F 17/30

(52) U.S. Cl. 707/3; 707/10

(57) ABSTRACT

A method, apparatus, and system for unifying heterogeneous data sources for access from online applications are described. In one embodiment, a query request to retrieve data stored in a plurality of disparate data sources is retrieved. At least one output mapping is activated to retrieve the stored data. The stored data are retrieved from the plurality of disparate data sources. The stored data are displayed in a uniform external view for the user. If the user decides to update the displayed data, a request to update the stored data in respective data sources and the updated data are received. At least one input mapping is activated to update the respective data sources. The updated data are further processed to obtain processed data, which conforms to a format of the respective data sources. Finally, the respective data sources are updated with the processed data.

### TECHNICAL FIELD

The invention relates generally to the field of network-based communications and, more particularly, to a method, apparatus, and system for unifying heterogeneous data sources for access from online applications over a network, such as the Internet.

### BACKGROUND OF THE INVENTION

The explosive growth of the Internet as a publication and interactive communication platform has created an electronic environment that is changing the way business is transacted and the way entertainment is perceived. As the Internet becomes increasingly accessible around the world, communications among users increase exponentially and efficient navigation of the information becomes essential.

Over the years, companies have created an increasing number of disparate data sources. Consequently, several attempts have been made to develop applications, which make disparate data sources appear as one database and which enable users to apply data management queries to the pooled data to support applications that present or analyze data in new and improved ways. In one such example, the DB2 Information Integrator, available from International Business Machines (IBM), creates an abstract relational view across diverse data, including DB2 DB, Microsoft SQL Server, Oracle, etc., and uses SQL-based tools for data development and reporting.

However, these solutions require application developers to write complex software programs and appear to lack key functionalities including access control across data sources, data quality control, data encoding conversion for internalization support, and scalability.

### SUMMARY OF THE INVENTION

A method, apparatus, and system for unifying heterogeneous data sources for access from online applications are described. In one preferred embodiment, a query request to retrieve data stored in a plurality of disparate data sources is retrieved. At least one output mapping is activated to retrieve the stored data. The stored data are further retrieved from the plurality of disparate data sources. The stored data are further displayed in a uniform external view for the user. In the preferred embodiment, if the user decides to update the displayed data, a request to update the stored data in respective data sources and the updated data are received. At least one input mapping is activated to update the respective data sources. The updated data are further processed to obtain processed data, which conforms to a format of the respective data sources. Finally, the respective data sources are updated with the processed data. The system thus presents applications with uniform views, each of which being specified as a system configuration. Furthermore, the system supports, for example, both relational views and XML views and has a mechanism for data quality control and data format conversion.

### BRIEF DESCRIPTION OF THE DRAWINGS

FIG. 1 is a block diagram illustrating an exemplary network-based transaction and communications facility, which includes a unified profile platform for unifying heterogeneous data sources for access from online applications according to one embodiment of the invention;

FIG. 2 is a block diagram illustrating a unified profile platform within the network-based server facility according to one embodiment of the invention;

FIG. 3 is a block diagram illustrating exemplary external views for the disparate data sources according to one embodiment of the invention;

FIG. 4 is a block diagram illustrating exemplary mappings between external views and physical disparate data sources according to one embodiment of the invention;

FIG. 5A is a flow diagram illustrating a method for retrieving data from heterogeneous data sources according to one embodiment of the invention;

FIG. 5B is a flow diagram illustrating a method for updating data in heterogeneous data sources according to one embodiment of the invention; and

FIG. 6 is a diagrammatic representation of a machine in the exemplary form of a computer system within which a set of instructions may be executed.

### DETAILED DESCRIPTION

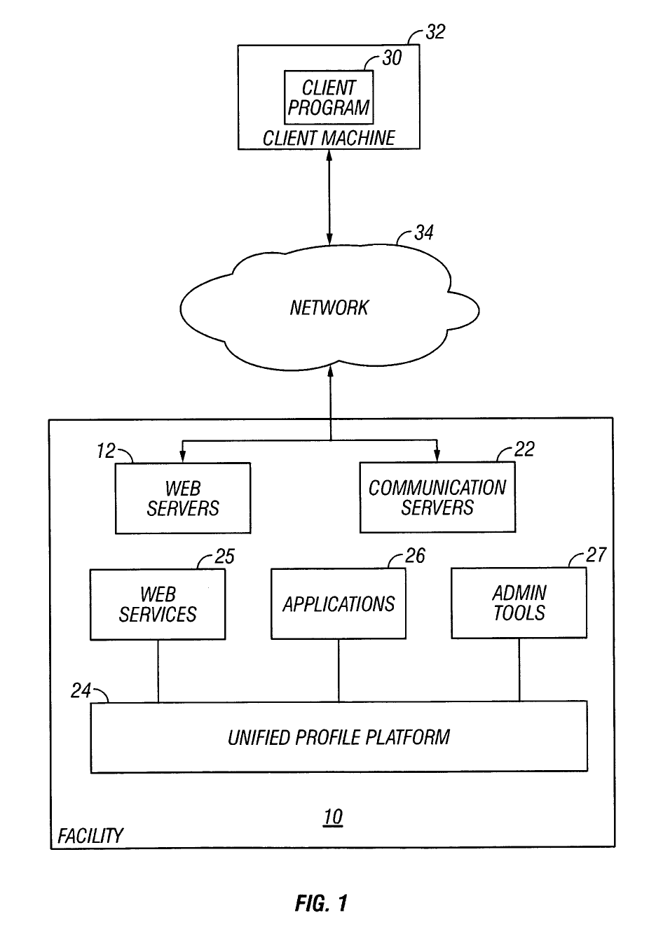

FIG. 1 is a block diagram illustrating an exemplary network-based transaction and communications facility, which includes a unified profile platform for unifying heterogeneous data sources for access from online applications. While an exemplary embodiment of the invention is described within the context of a network transaction and communications facility 10, it will be appreciated by those skilled in the art that the invention will find application in many different types of computer-based and network-based facilities.

The facility 10 includes one or more of a number of types of front-end Web servers 12, such as, for example, Web page servers, which deliver Web pages to multiple users, Web picture servers, which deliver images to be displayed within the Web pages, and Web content servers, which dynamically deliver content information (audio and video data) to the users. In addition, the facility 10 may include communication servers 22 that provide, inter alia, automated real-time communications, such as, for example, instant messaging (IM) functionality, to/from users of the facility 10, and automated electronic mail (email) communications to/from such users.

The facility 10 further includes several software applications, such as, for example, Web services 25, applications 26, and administration tools 27, which are configured to enable functionality of the facility 10. The facility 10 further includes one or more back-end servers coupled to the Web services 25, applications 26, and administration tools 27, such as a unified profile platform 24, which is a hardware and/or software module for unifying heterogeneous data sources for access from online applications, as described in further detail below, and other known back-end servers configured to enable the functionality of the facility 10. The network-based facility 10 may be accessed by a client program 30, such as a browser, e.g. the Internet Explorer browser distributed by Microsoft Corporation of Redmond, Wash., that executes on a client machine 32 and accesses the facility 10 via a network 34, such as, for example, the Internet. Other examples of networks that a client may utilize to access the facility 10 includes a wide area network (WAN), a local area network (LAN), a wireless network, e.g. a cellular network, the Plain Old Telephone Service (POTS) network, or other known networks.

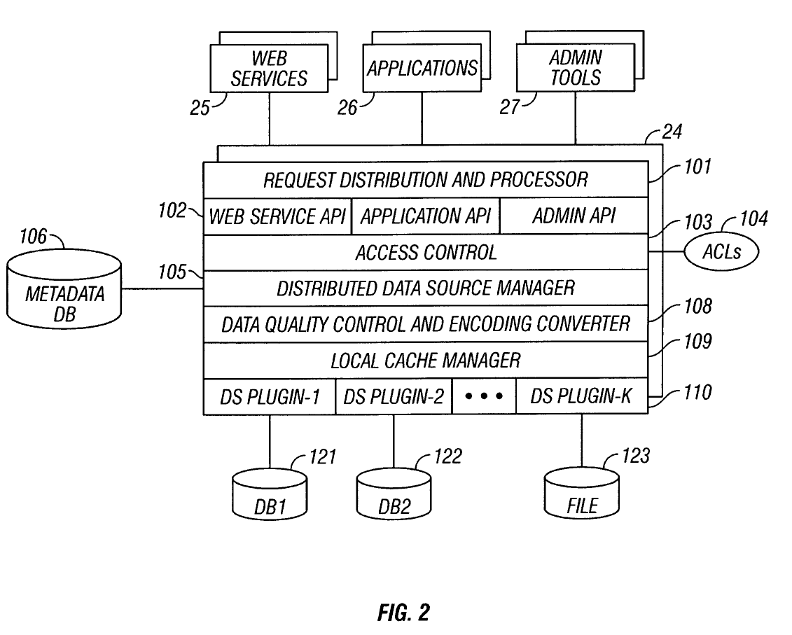

FIG. 2 is a block diagram illustrating a unified profile platform within the network-based server facility 10, according to one embodiment of the invention. As illustrated in FIG. 2, in one embodiment, the unified profile platform 24 is coupled to multiple disparate data sources directly or via the network 34, of which database modules DB1 121 and DB2 122 and file module 123 are shown. Database modules 121 and 122 may, in one embodiment, be implemented as relational databases, and may include a number of tables having entries, or records, that are linked by indices and keys. In an alternate embodiment, each database module 121, 122, 123 may be implemented as a collection of objects in an object-oriented database.

In one embodiment, the unified profile platform 24 further includes a request distribution module and processor 101 configured to enable distribution and processing of incoming user requests received from the client machine 32; multiple application program interfaces (API) 102, such as, for example, Web services API, applications API, administration API corresponding to the Web services 25, applications 26, and administration tools 27, respectively, which are sets of routines, protocols, and tools configured to enable building of the respective software applications; and an access control module 103 for specifying access rights of the software applications. The access control module 103 is further coupled to several access control libraries (ACL) 104, which store data related to the access priorities of the applications.

In one embodiment, the platform 24 further includes a distributed data source manager module 105, which provides an external view of each disparate data source 121-123 and is coupled to a metadata database 106. The metadata database 106 may, in one embodiment, be implemented as a relational database, or may, in an alternate embodiment, be implemented as a collection of objects in an object-oriented database. The metadata database 106 stores metadata associated with data entries stored in the data sources 121-123 accessed by the user. In one embodiment, metadata associated with the data entries may include a number of parameters, such as, for example, a CreationTime parameter, which indicates the creation date and time of a corresponding data entry, such as a time stamp, a ModificationTime parameter, which indicates the last modification of the corresponding data entry, a Version parameter, which indicates how many times has the corresponding data entry been modified, and an ApplicationID parameter, which indicates the application that performed the last modification on the corresponding data entry. It is to be understood that the metadata stored in the metadata database 106 may contain additional parameters associated with data entries stored in the data sources 121 through 123.

In one embodiment, the unified profile platform 24 further includes a data quality control and encoding converter module 108, a local cache manager module 109 for storing database content in a local cache memory within the platform 24, and multiple data source plug-in modules 110, each module 110 corresponding to a data source 121, 122, or 123, respectively, and being configured to couple the respective data source to the platform 24.

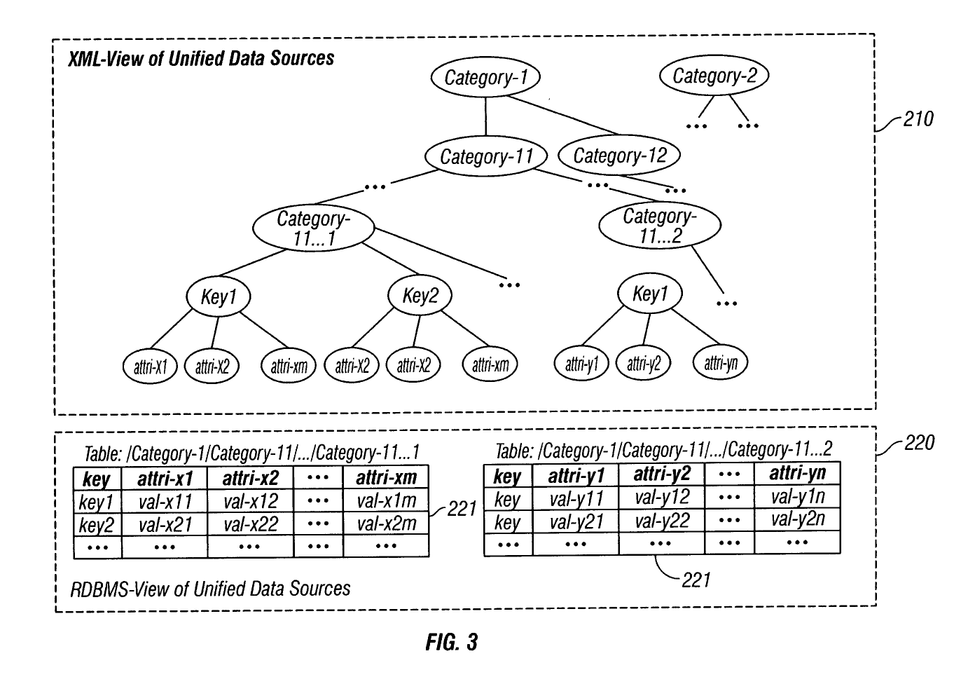

FIG. 3 is a block diagram illustrating exemplary external views for the disparate data sources, according to one embodiment of the invention. As illustrated in FIG. 3, in one embodiment, the distributed data source manager 105 may present a uniform XML-based hierarchical view 210 of the content stored in the disparate data sources 121-123, the view containing parent and child nodes corresponding to the content stored in the data sources. In an alternate embodiment, the distributed data source manager 105 may present a uniform relational database view 220 of the content stored in the data sources 121-123, the view 220 further containing multiple tables 221 having columns containing indices and keys.

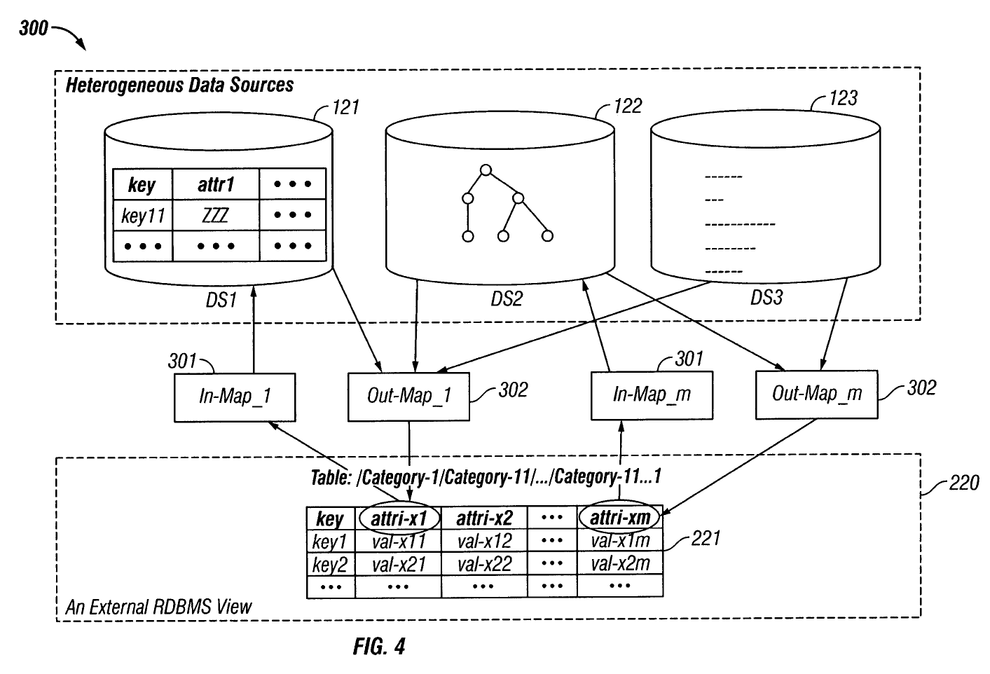

FIG. 4 is a block diagram illustrating exemplary mappings between external views and physical disparate data sources, according to one embodiment of the invention. As illustrated in FIG. 4, two-way mappings are created between the illustrated external view 220 and the disparate data sources 121 through 123. In one embodiment, the distributed data source manager module 105 creates the mappings and stores the mappings for further processing of stored data.

For each attribute in the external view 220, there is at least one input mapping 301 for updating data from the external views into the data sources. In one embodiment, when an attribute is modified in the external view 220, the corresponding input mapping 301 is activated to update the appropriate data sources 121-123. Similarly, for each attribute in the external view 220, there is at least one output mapping 302 for retrieving data from data sources into the external views. In one embodiment, when a query request is executed against the external view 220, the corresponding set of output mappings 302 is activated to retrieve data from the appropriate data sources 121-123. All input mappings 301 and output mappings 302 are defined as part of an administration process within the facility 10 using the administration tools 27 and may be built-in or, in the alternative, may be customizable. In one embodiment, the mappings 301 and 302 are invisible to the Web services 25 and the applications 26.

In one embodiment, a user at the client machine 32 selects an external view 210 or 220 to view requested data, such as, for example, the relational database view 220, and transmits a query request to the facility 10 to request data from the disparate data sources 121-123. The query request may include one or more parameters, such as, for example, the ApplicationID parameter, a Key parameter of the desired data entry, a list of data fields in the corresponding data entry specified via XPath or XQuery expressions, and metadata associated with each data field, such as the Version parameter. For example, a query containing the above parameters may be transmitted in XML format as follows:

<methodCall>

<methodName>up.get</methodName>
<params><param> <struct>

<member><name>application_id</name><value><string>XY</string></value></member>

<member><name>key</name><value><string>key1</string></value></member>
<member><name>attributes</name>

<value><array><data>

<value>/Category-1/Category-11/.../Category-11...1/</value>
<value>/Category-1/Category-11/.../Category-11...2/attri-y1</value>

</data></array></value></member>

<member><name>version</name><value><string>“ ” </string></value></member>

</struct></param></params>

</methodCall>

When the query request is received from the client machine 32 via the network 34 and the communication servers 22, the distributed data source manager module 105 within the unified profile platform 24 activates the output mappings 302 to retrieve the requested data from the disparate data sources 121 through 123. The output mappings 302 retrieve the requested data and, subsequently, the manager module 105 transmits the data to the user via the communication servers 22 and the network 34 for display in the selected external view 210 or 220.

In one embodiment, the response to the query request may include one or more response parameters, such as, for example, a name and value for each data field and associated metadata with respective values. For example, the response may be transmitted in XML format as follows:

<methodResponse>

<params><param><value><struct><member>

<name>attributes</name><value><struct>

<member><name>/Category-1/Category-11/.../Category-11...1/attri-x1</name>

<value><struct>
<member><name>values</name><value><string>val-

x11</string></value></member>

<member><name>version</name><value><string>2</string></value></member>

</struct></value></member>
<member><name>/Category-1/Category-11/.../Category-11...1/attri-x2</name>

<value><struct>

<member><name>values</name><value><string>val-

x12</string></value></member>

<member><name>version</name><value><string>4</string></value></member>

</struct></value></member>
<member><name>/Category-1/Category-11/.../Category-11...1/attri-xm</name>

<value><struct>

<member><name>values</name><value><string>val-

x1m</string></value></member>

<member><name>version</name><value><string>1</string></value></member>

</struct></value></member>
<member><name>/Category-1/Category-11/.../Category-11...2/attri-y1</name>

<value><struct>

<member><name>values</name><value><string>val-

y11</string></value></member>

<member><name>version</name><value><string>2</string></value></member>

</struct></value></member>

</struct></value></member></struct></value></param></params>

</methodResponse>

In one embodiment, if the user decides to update some data displayed in the external view 220, the user transmits the updated data and a request to update such data to the distributed data source manager module 105. The update request may include one or more parameters, such as, for example, the ApplicationID parameter, a Key parameter of the desired data entry, a list of name/value pairs for update data fields in the corresponding data entry, and metadata associated with each data field, such as the Version parameter.

When the request is received from the client machine 32 via the network 34 and the communication servers 22, the manager module 105 activates the input mappings 301 to update the corresponding data sources 121 through 123 with the updated data. Subsequently, the converter module 108 within the platform 24 uses the input mappings 301 for processing the updated data to conform it to the format of the appropriate data sources, such as, for example, performing data quality control and encoding, and the data sources 121 through 123 are updated accordingly.

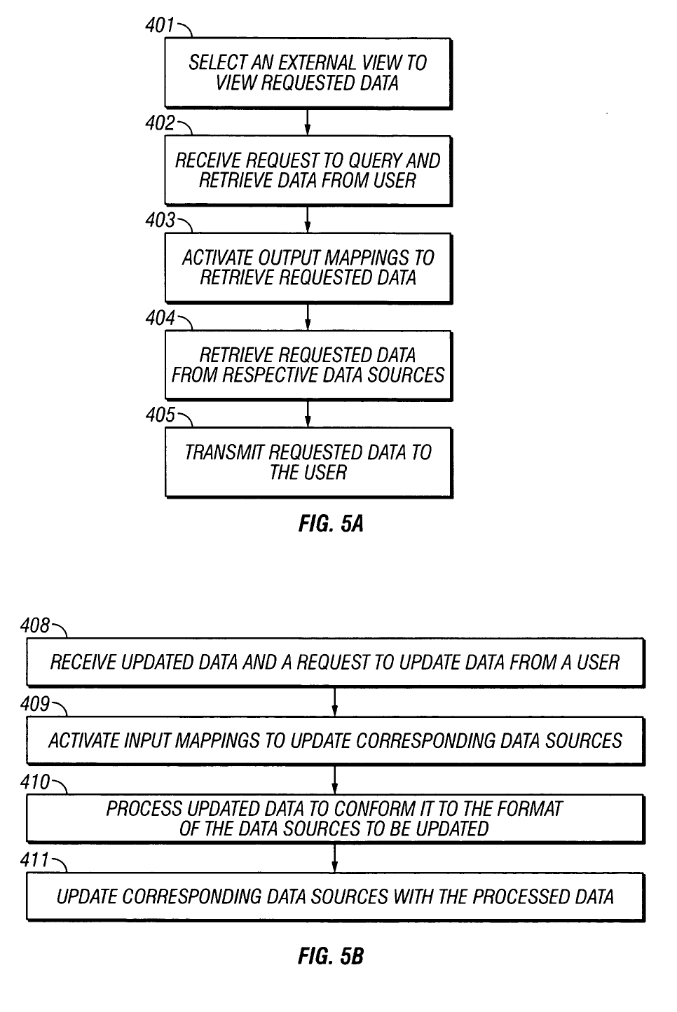

FIG. 5A is a flow diagram illustrating a method for retrieving data from heterogeneous data sources, according to one embodiment of the invention. As illustrated in FIG. 5A, at processing block 401, an external view to view requested data is selected.

At processing block 402, a request to query and retrieve data is received from a user. At processing block 403, output mappings are activated to retrieve the requested data. At processing block 404, the requested data are retrieved from the respective data sources. At processing block 405, the retrieved data are transmitted to the user for display in the selected external view.

FIG. 5B is a flow diagram illustrating a method for updating data in the heterogeneous data sources, according to one embodiment of the invention. In one embodiment, if the user decides to update the displayed data, at processing block 408, the updated data and a request to update the data are received from the user. At processing block 409, input mappings are activated to update the corresponding data sources with the updated data. At processing block 410, the updated data are processed to conform it to the format of the data sources. Finally, at processing block 411, the data sources are updated with the processed updated data.

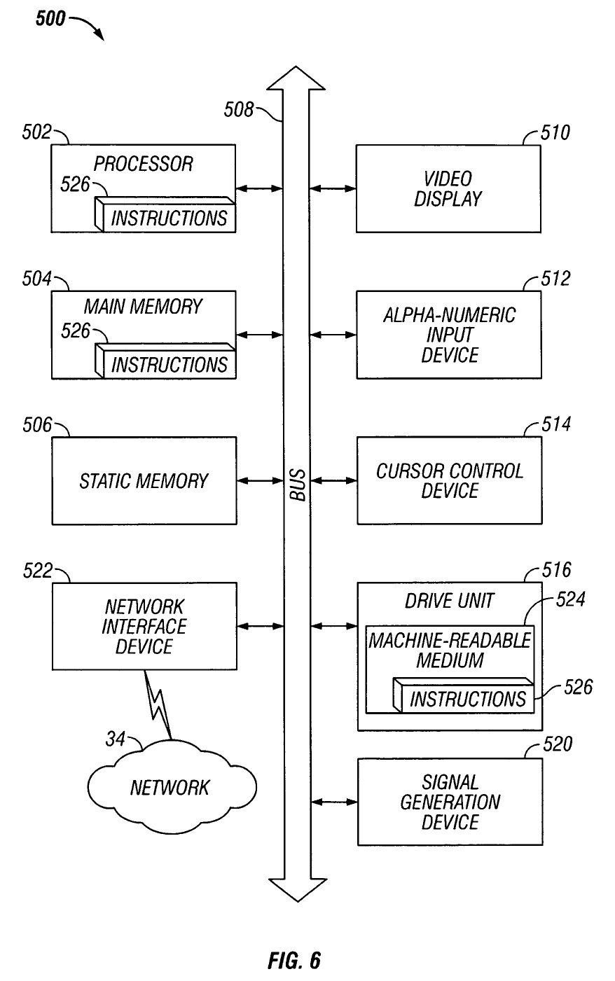

FIG. 6 shows a diagrammatic representation of a machine in the exemplary form of a computer system 500 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a Web appliance or any machine capable of executing a sequence of instructions that specify actions to be taken by that machine.

The computer system 500 includes a processor 502, a main memory 504 and a static memory 506, which communicate with each other via a bus 508. The computer system 500 may further include a video display unit 510, e.g. a liquid crystal display (LCD) or a cathode ray tube (CRT). The computer system 500 also includes an alphanumeric input device 512, e.g, a keyboard, a cursor control device 514, e.g. a mouse, a disk drive unit 516, a signal generation device 518, e.g. a speaker, and a network interface device 520.

The disk drive unit 516 includes a machine-readable medium 524 on which is stored a set of instructions, i.e. software, 526 embodying any one, or all, of the methodologies described above. The software 526 is also shown to reside, completely or at least partially, within the main memory 504 and/or within the processor 502. The software 526 may further be transmitted or received via the network interface device 520.

It is to be understood that embodiments of this invention may be used as or to support software programs executed upon some form of processing core (such as the CPU of a computer) or otherwise implemented or realized upon or within a machine or computer readable medium. A machine readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, e.g. carrier waves, infrared signals, digital signals, etc.; or any other type of media suitable for storing or transmitting information.

In the foregoing specification, the invention has been described with reference to specific exemplary embodiments thereof. It will, however, be evident that various modifications and changes may be made thereto without departing from the broader spirit and scope of the invention as set forth in the appended Claims. The specification and drawings are, accordingly, to be regarded in an illustrative sense rather than a restrictive sense.

1. A method, comprising the steps of:
receiving a query request to retrieve data stored in a plurality of disparate data sources;
activating at least one output mapping to retrieve said stored data;
retrieving said stored data from said plurality of disparate data sources using said at least one output mapping; and
displaying said stored data in a uniform external view for said user.

2. The method according to claim 1, further comprising the steps of:
receiving an update request to update said stored data in respective data sources of said plurality of disparate data sources with updated data;
receiving said updated data;
activating at least one input mapping to update said respective data sources;
processing said updated data to obtain processed data, which conform to a format of said respective data sources; and
updating said respective data sources with said processed data using said at least one input mapping.

3. The method according to claim 1, wherein said at least one output mapping is defined as part of an administration process using a plurality of administration tools.

4. The method according to claim 2, wherein said at least one input mapping is defined as part of an administration process using a plurality of administration tools.

5. The method according to claim 2, wherein said stored data further comprise at least one data entry having a plurality of data fields, and wherein a response to said query request further comprises a name and value pair for each data field of said plurality of data fields and associated metadata.

6. A method, comprising the steps of:
receiving an update request to update stored data in respective data sources of a plurality of disparate data sources with updated data;
receiving said updated data;
activating at least one input mapping to update said respective data sources;
processing said updated data to obtain processed data, which conform to a format of said respective data sources; and
updating said respective data sources with said processed data using said at least one input mapping.

7. The method according to claim 6, further comprising the steps of:
receiving a query request to retrieve said stored data from said plurality of disparate data sources;
activating at least one output mapping to retrieve said stored data;
retrieving said stored data from said plurality of disparate data sources using said at least one output mapping; and
displaying said stored data in a uniform external view for said user.

8. The method according to claim 6, wherein said at least one input mapping is defined as part of an administration process using a plurality of administration tools.

9. The method according to claim 7, wherein said at least one output mapping is defined as part of an administration process using a plurality of administration tools.

10. The method according to claim 7, wherein said uniform external view is an Extensible Markup Language (XML) based hierarchical view of said stored data containing parent and child nodes corresponding to content in said stored data.

11. The method according to claim 7, wherein said uniform external view is a uniform relational database view of said stored data containing a plurality of tables having columns comprising indices and keys associated with said stored data.

12. A machine-readable medium containing executable instructions, which, when executed in a processing system, cause said system to perform a method comprising the steps of:
receiving a query request to retrieve data stored in a plurality of disparate data sources;
activating at least one output mapping to retrieve said stored data;
retrieving said stored data from said plurality of disparate data sources using said at least one output mapping; and
displaying said stored data in a uniform external view for said user.

13. A machine-readable medium containing executable instructions, which, when executed in a processing system, cause said system to perform a method comprising the steps of:
receiving an update request to update stored data in respective data sources of a plurality of disparate data sources with updated data;
receiving said updated data;
activating at least one input mapping to update said respective data sources;
processing said updated data to obtain processed data, which conform to a format of said respective data sources; and
updating said respective data sources with said processed data using said at least one input mapping.

14. An apparatus, comprising:
means for receiving a query request to retrieve data stored in a plurality of disparate data sources;
means for activating at least one output mapping to retrieve said stored data;
means for retrieving said stored data from said plurality of disparate data sources using said at least one output mapping; and
means for displaying said stored data in a uniform external view for said user.

15. An apparatus, comprising:
means for receiving an update request to update stored data in respective data sources of a plurality of disparate data sources with updated data;
means for receiving said updated data;
means for activating at least one input mapping to update said respective data sources;
means for processing said updated data to obtain processed data, which conform to a format of said respective data sources; and
means for updating said respective data sources with said processed data using said at least one input mapping.

16. A system, comprising:
a plurality of disparate data sources; and
a unified profile platform coupled to said plurality of disparate data sources, said unified profile platform further comprising a distributed data manager module for receiving a query request to retrieve data stored in said plurality of disparate data sources, for activating at least one output mapping to retrieve said stored data, for retrieving said stored data from said plurality of disparate data sources using said at least one output mapping, and for displaying said stored data in a uniform external view for said user.

17. The system according to claim 16, wherein said unified profile platform further comprises a data control and encoding converter module coupled to said distributed data manager module.

18. The system according to claim 17, wherein said distributed data manager module further receives an update request to update said stored data in respective data sources of said plurality of disparate data sources with updated data, receives said updated data, activates at least one input mapping to update said respective data sources, wherein said converter module further processes said updated data to obtain processed data, which conform to a format of said respective data sources, and said distributed data manager module further updates said respective data sources with said processed data using said at least one input mapping.

19. The system according to claim 16, wherein said uniform external view is an Extensible Markup Language (XML) based hierarchical view of said stored data containing parent and child nodes corresponding to content in said stored data.

20. The system according to claim 16, wherein said uniform external view is a uniform relational database view of said stored data containing a plurality of tables having columns comprising indices and keys associated with said stored data.

21. The system according to claim 16, wherein said unified profile platform further comprises a local cache manager module for storing said stored data locally in a local memory within said unified profile platform.
